(19) United States
(12) Patent Application Publication
(10) Pub. No.: US 2026/0229781 A1
(43) Pub. Date: Aug. 6, 2026

(54) CIRCULARLY POLARIZED ANTENNA, ARRAY ANTENNA, AND COMMUNICATION DEVICE

(71) Applicants: BEIJING BOE TECHNOLOGY DEVELOPMENT CO., LTD., Beijing (CN); BOE TECHNOLOGY GROUP CO., LTD., Beijing (CN)

(72) Inventors: Yu Luo, Beijing (CN); Shiqiao Zhang, Beijing (CN); Jia Fang, Beijing (CN); Chunxin Li, Beijing (CN); Jie Cao, Beijing (CN); Biqi Li, Beijing (CN)

(73) Assignees: BEIJING BOE TECHNOLOGY DEVELOPMENT CO., LTD., Beijing (CN); BOE TECHNOLOGY GROUP CO., LTD., Beijing (CN)

(21) Appl. No.: 19/149,379

(22) PCT Filed: Jul. 9, 2024
(86) PCT No.: PCT/CN2024/104536

§ 371 Date: Jul. 18, 2025

(30) Foreign Application Priority Data
Aug. 15, 2023 (CN) 202311029974.8

(51) Int. Cl. H01Q 9/04; H01Q 21/06

(52) U.S. Cl. CPC H01Q 9/0435; H01Q 21/065

(57) ABSTRACT

A circularly polarized antenna includes a radiating patch, a ground layer, a dielectric layer and a power divider module; the radiating patch and the ground layer are arranged opposite to each other, and the dielectric layer is located between the radiating patch and the ground layer; the power divider module includes an input terminal and two output terminals, a phase difference between output signals of the two output terminals is 90°; the radiating patch includes a first feed point and a second feed point, the first feed point is electrically connected to one of the two output terminals, and the second feed point is electrically connected to the other one of the two output terminals.

This application claims the priority of the Chinese Patent application filed on Aug. 15, 2023 before the CNIPA, China National Intellectual Property Administration with the application number of 202311029974.8, and the title of “CIRCULARLY POLARIZED ANTENNA, ARRAY ANTENNA, AND COMMUNICATION DEVICE”, which is incorporated herein in its entirety by reference.

### TECHNICAL FIELD

The present disclosure relates to the technical field of antennas and more particularly, to a circularly polarized antenna, an array antenna, and a communication device.

### BACKGROUND

The communication device usually includes the antenna, which can convert guided waves in the feeder line into electromagnetic waves and radiate them to the external space, or receive the electromagnetic waves from the external space and convert them into the guided waves. However, the size of the antenna in related art is relatively large.

### SUMMARY

Embodiments of the present disclosure provides a circularly polarized antenna, an array antenna, and a communication device, and the circularly polarized antenna has a small size and compact structure.

To achieve the above objectives, the embodiments of the present disclosure adopt the following technical solutions:
in one aspect, a circularly polarized antenna is provided, which includes a radiating patch, a ground layer, a dielectric layer and a power divider module; wherein the radiating patch and the ground layer are arranged opposite to each other, and the dielectric layer is located between the radiating patch and the ground layer; the power divider module includes an input terminal and two output terminals, a phase difference between output signals of the two output terminals is 90°; the radiating patch includes a first feed point and a second feed point, the first feed point is electrically connected to one of the two output terminals, and the second feed point is electrically connected to the other one of the two output terminals; and a virtual connection line of the first feed point and a center of the radiating patch is regarded as a first line, a virtual connection line of the second feed point and the center of the radiating patch is regarded as a second line, and an angle between the first line and the second line is less than 90°.

In some embodiments, the power divider module includes a power divider, a first signal line and a second signal line; the power divider includes a first output terminal and a second output terminal, the first signal line is electrically connected to the first output terminal and the first feed point, the second signal line is electrically connected to the second output terminal and the second feed point, and lengths of the first signal line and the second signal line are different.

In some embodiments, the circularly polarized antenna further includes a first conductive layer connected to one side of the dielectric layer away from the ground layer; the radiating patch, the power divider, the first signal line and the second signal line are located on the first conductive layer.

In some embodiments, the first conductive layer has two virtual straight lines that are parallel and arranged at an interval, the radiating patch is connected to the two virtual straight lines, and the radiating patch, the first signal line, the second signal line and the power divider are located between the two virtual straight lines.

In some embodiments, the first signal line includes a first feed segment, the first feed segment is electrically connected to the first feed point, the second signal line includes a second feed segment, the second feed segment is electrically connected to the second feed point, and the first feed segment and the second feed segment are parallel and arranged at an interval.

In some embodiments, phases of output signals of the first output terminal and the second output terminal are the same.

In some embodiments, a length difference between the first signal line and the second signal line is 2.8~3.8 mm, and/or, a distance between the first feed point and the second feed point is 4.9~5.9 mm.

In some embodiments, a shape of the radiating patch is circular, polygonal, or irregular.

In some embodiments, one radiating patch and one power divider module that are electrically connected forms an antenna unit, and the circularly polarized antenna includes at least two antenna units; and the circularly polarized antenna further includes a branch-line coupler, the branch-line coupler includes a plurality of input ports and at least two output ports, a phase difference between output signals of two adjacent of the at least two output ports is 90°, and each of the at least two output ports is connected to the antenna unit.

In some embodiments, two adjacent radiating patches are arranged at an interval, and a distance between centers of the two adjacent radiating patches is half of a spatial wavelength.

In some embodiments, a plurality of conductive pillars are provided between the two adjacent radiating patches, and an axial direction of each of the plurality of conductive pillars is perpendicular to the ground layer; and/or, a neutralization line is provided between the two adjacent radiating patches, one end of the neutralization line is electrically connected to one of the two adjacent radiating patches, and the other end of the neutralization line is electrically connected to the other one of the two adjacent radiating patches; and/or, the ground layer is provided with a defective ground structure.

In some embodiments, the dielectric layer is provided with a plurality of openings, and the plurality of conductive pillars are arranged in the plurality of openings.

In some embodiments, the circularly polarized antenna includes at least three antenna units, and the branch-line coupler includes at least three output ports.

In some embodiments, filters are connected between the at least three output ports and the input terminal.

In another aspect, an array antenna is provided, which includes a plurality of circularly polarized antennas as described above, and the plurality of circularly polarized antennas are arranged in an array.

In some embodiments, the plurality of circularly polarized antennas includes a plurality of circularly polarized antenna rows, a plurality of circularly polarized antennas in each of the plurality of circularly polarized antenna rows are arranged at an interval along a first direction, two adjacent circularly polarized antennas in each of the plurality of circularly polarized antenna rows are staggered at a predetermined distance along a second direction, and the first direction intersects with the second direction.

In some embodiments, the array antenna further includes a phase shifter, the phase shifter is connected to an input port of the circularly polarized antenna, and/or, the phase shifter is connected between an output port of the circularly polarized antenna and an input terminal of an antenna unit.

In some embodiments, the phase shifter is a liquid crystal phase shifter, and the dielectric layer serves as a substrate of the liquid crystal phase shifter.

In some embodiments, the array antenna further includes a power regulator, the power regulator is configured for amplifying or attenuating electrical signals; the power regulator is connected to an input port of the circularly polarized antenna, and/or the power regulator is connected between an output port of the circularly polarized antenna and an input terminal of an antenna unit.

In yet another aspect, a communication terminal is provided, which includes the array antenna as described above.

In the circularly polarized antenna, the array antenna, and the communication device provided in the embodiments of the present disclosure, the radiating patch includes a first feed point and a second feed point, the first feed point is electrically connected to one of the two output terminals, and the second feed point is electrically connected to the other one of the two output terminals; and a virtual connection line of the first feed point and a center of the radiating patch is regarded as a first line, a virtual connection line of the second feed point and the center of the radiating patch is regarded as a second line, and an angle between the first line and the second line is less than 90°. Unlike the circularly polarized antennas in related art using an orthogonal feeding method, this embodiment of the present disclosure utilizes the phase difference between the two output terminals of the power divider module and the different positions of the first feed point and the second feed point, to achieve antenna circular polarization while reducing the size of the antenna along the first direction.

### BRIEF DESCRIPTION OF THE DRAWINGS

In order to more clearly illustrate the technical solution of the embodiments of the present disclosure or related art, a brief introduction will be given to the accompanying drawings required to be used in the embodiments or the related art. It is obvious that the accompanying drawings described below are only some embodiments of the present disclosure. For those skilled in the art, other drawings may be obtained based on these drawings without creative work.

FIG. 1 exemplarily illustrates an application scenario diagram of a communication terminal;

FIG. 2 illustrates a front view of a circularly polarized antenna in related art;

FIG. 3 exemplarily illustrates a front view of a circularly polarized antenna;

FIG. 4 is a cross-segmental view of A-A in FIG. 3;

FIG. 5 exemplarily illustrates an exploded view of a circularly polarized antenna;

FIG. 6 exemplarily illustrates a partial structural schematic diagram of a circularly polarized antenna;

FIG. 7 exemplarily illustrates a partial structure of a circularly polarized antenna;

FIG. 8 illustrates a 3D directional diagram of the circularly polarized antenna shown in FIG. 3;

FIG. 9 illustrates an input impedance bandwidth diagram of the circularly polarized antenna shown in FIG. 3;

FIG. 10 illustrates a curve of an axial ratio of the circularly polarized antenna shown in FIG. 3 varies with the frequency;

FIG. 11 illustrates a diagram of the axial ratio of the circularly polarized antenna shown in FIG. 3 varies with Theta in FIG. 8;

FIG. 12 exemplarily illustrates a front view of another circularly polarized antenna;

FIG. 13 is a 3D directional diagram of the circularly polarized antenna shown in FIG. 12;

FIG. 14 illustrates an input impedance bandwidth diagram of the circularly polarized antenna shown in FIG. 12;

FIG. 15 illustrates a curve of an axial ratio of the circularly polarized antenna shown in FIG. 12 varies with the frequency;

FIG. 16 exemplarily illustrates a front view of another circularly polarized antenna;

FIG. 17 exemplarily illustrates a structure of another circularly polarized antenna;

FIG. 18 exemplarily illustrates a structure of another circularly polarized antenna;

FIG. 19 exemplarily illustrates a structure of another circularly polarized antenna;

FIG. 20 exemplarily illustrates a structure of a ground layer;

FIG. 21 exemplarily illustrates a structure of an array antenna;

FIG. 22 exemplarily illustrates a structure of another array antenna;

FIG. 23 is a 3D directional diagram of the array antenna shown in FIG. 21;

FIG. 24 to FIG. 34 exemplarily illustrate a layout diagram of the radiating patches in an array antenna;

FIG. 35 exemplarily illustrates a structure of another array antenna;

FIG. 36 shows beam directions corresponding to different phase differences of the array antenna shown in FIG. 35;

FIG. 37 exemplarily illustrates a structure of another array antenna;

FIG. 38 exemplarily illustrates a structure of another array antenna;

FIG. 39 exemplarily illustrates a structure of another array antenna; and

FIG. 40 exemplarily illustrates a structure of another array antenna.

### DETAILED DESCRIPTION

Below, a clear and complete description of the technical solution in the embodiments of the present disclosure will be provided in conjunction with the accompanying drawings. Obviously, the described embodiments are only a part of the embodiments of the present disclosure, not all of them. Based on the embodiments of the present disclosure, all other embodiments obtained by persons skilled in the art without creative work are within the scope of protection of the present disclosure.

In the embodiments of the present disclosure, the use of words such as “first”, “second”, “third”, “fourth” to distinguish similar or identical items with similar functions and effects is only for the purpose of clearly describing the technical solution of the embodiments of the present disclosure, and cannot be understood as indicating or implying relative importance or implying the number of technical features indicated.

In the embodiments of the present disclosure, the meaning of “multiple” refers to two or more, and the meaning of “at least one” refers to one or more, unless otherwise specified.

In the embodiments of the present disclosure, the terms “up”, “down”, etc. indicate orientation or positional relationships based on the orientation or positional relationships shown in the accompanying drawings. This is only for the convenience of describing and simplifying the description of the present disclosure, and does not indicate or imply that the device or element referred to must have a specific orientation, be constructed and operated in a specific orientation, and therefore cannot be understood as a limitation of the present disclosure.

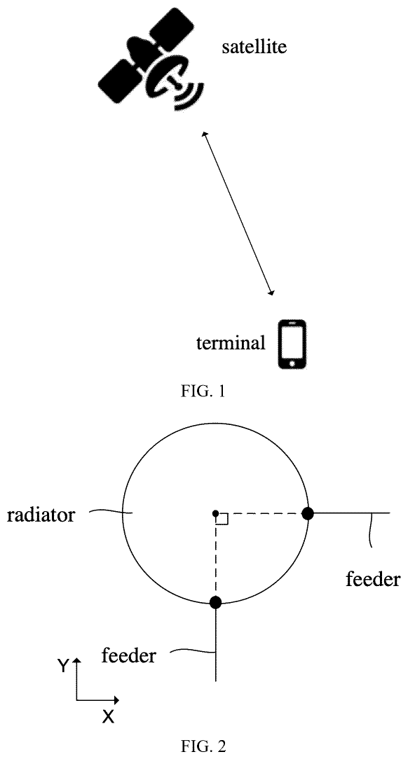

The embodiment of the present disclosure provides a communication terminal that can wirelessly communicate with an external device. FIG. 1 exemplarily illustrates an application scenario diagram of a communication terminal. As shown in FIG. 1, wireless communication can be conducted between the communication terminal and a satellite. The embodiment shown in FIG. 1 is illustrated using a mobile phone as an example. It can be understood that the communication terminal can also be other electronic devices. The embodiment of the present disclosure does not limit the type of the communication device, as long as it can achieve the wireless communication with the external device.

The communication terminal includes a circularly polarized antenna, and the wireless communication between the communication terminal and the external device may be achieved through the circularly polarized antenna. Among them, the circularly polarized antenna can be used as a transmitting antenna or a receiving antenna. When the circularly polarized antenna is used as the transmitting antenna, it converts radio frequency currents in a guided wave mode into spatial electromagnetic waves in a diffused wave mode. When the circularly polarized antenna is used as the receiving antenna, it intercepts the spatial electromagnetic waves in the diffuse wave mode and converts the electromagnetic waves into the radio frequency currents in the guided wave mode.

For example, the communication terminal includes a housing, as well as the circularly polarized antenna, feeder lines, a receiving device, and a transmitting device that are arranged in the housing. The feeder line electrically connects the circularly polarized antenna and the transmitting device, and the feeder line electrically connects the circularly polarized antenna and the receiving device. When the circularly polarized antenna is used as the transmitting antenna, the radio frequency current signal emitted by the transmitting device is fed into the circularly polarized antenna through the feeder line. When the circularly polarized antenna is used as the receiving antenna, the current signal converted by the circularly polarized antenna is input to the receiving device through the feeder line.

In practical applications, the communication terminal can also include batteries, which provide electrical energy to various active components inside the communication terminal.

FIG. 2 shows a front view of a circularly polarized antenna in related art. As shown in FIG. 2, the circularly polarized antenna in related art includes a circular radiator and two feeder lines connected to the radiator. The connection points between the two feeder lines and the radiator are the feed points, which are respectively connected to the center of the radiator to form two virtual connection lines (dashed lines in FIG. 2). The two virtual connection lines are perpendicular to each other to achieve circular polarization of the antenna. Due to the need for the two virtual connection lines to be perpendicular to each other, one feeder line extends along the first direction X, and the other feeder line extends along the second direction Y, resulting in a larger lateral size of the circularly polarized antenna in related art, that is, the size of the circularly polarized antenna along the first direction X shown in FIG. 2 is larger, which cannot meet the miniaturization requirements of the communication terminal. Specifically, in related art, one of the feeder lines of the antenna needs to extend along the meridian of the radiator along the first direction X, resulting in the location of this feeder line exceeding the outermost area of the radiator along the first direction X.

In view of this, the embodiment of the present disclosure provides a circularly polarized antenna with a compact structure and small size. Among them, the circularly polarized antenna may be a microstrip antenna, a dielectric antenna, a cross dipole antenna, etc. For the sake of convenience in description, the following only takes the example of the circularly polarized antenna being the microstrip antenna for illustrative purposes.

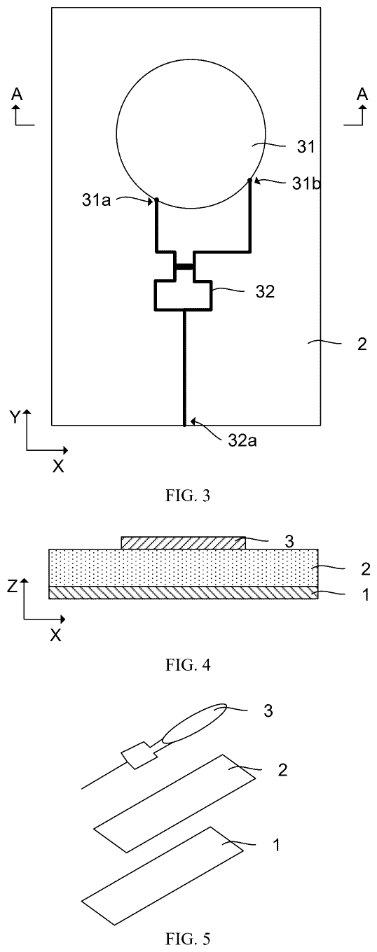

FIG. 3 exemplarily illustrates a front view of a circularly polarized antenna, FIG. 4 is a cross-segmental view of A-A in FIG. 3, and FIG. 5 exemplarily illustrates an exploded view of a circularly polarized antenna. As shown in FIG. 3 to FIG. 5, the circularly polarized antenna 100 includes a radiating patch 31, a ground layer 1, and a dielectric layer 2. The radiating patch 31 and the ground layer 1 are arranged opposite to each other, and the dielectric layer 2 is located between the radiating patch 31 and the ground layer 1.

The dielectric layer 2 can be a sheet made of low loss hard materials such as quartz, ceramics, graphene, glass, etc. The dielectric layer 2 can also be a low loss printed circuit board (PCB), such as polytetrafluoroethylene F4BM high-frequency antenna board. Certainly, the dielectric layer 2 can also be made of other materials, and the embodiment of the present disclosure does not limit the material of the dielectric layer.

The thickness direction of the dielectric layer 2 is the third direction Z in FIG. 4, and the thickness of the dielectric layer 2 can be less than the working wavelength. For example, the thickness of the dielectric layer 2 is greater than 0.025 times the working wavelength and less than the working wavelength. In practical applications, the thickness of the dielectric layer 2 can be flexibly adjusted as needed. When the thickness of the dielectric layer 2 is set relatively thin, impedance mismatch can be reduced, the gain of the antenna can be increased, the bandwidth of the antenna can be increased, and the overall size of the circularly polarized antenna can be reduced. When the thickness of the dielectric layer 2 is set to be thicker, it can make the radiation of the circularly polarized antenna more uniform.

The dielectric layer 2 includes a first side and a second side perpendicular to the thickness direction, the radiating patch 31 is located on the first side of the dielectric layer 2, and the ground layer 1 is located on the second side of the dielectric layer 2.

The radiating patch 31 and the ground layer 1 are made of conductive materials, such as gold, silver, copper, and other low loss metal materials. Among them, the materials of the ground layer 1 and the radiating patch 31 can be the same, for example, both the ground layer 1 and the radiating patch 31 are made of copper. The materials of the ground layer 1 and the radiating patch 31 can also be different, for example, the ground layer 1 is made of copper, while the radiating patch is made of gold.

The ground layer 1 and the radiating patch 31 can be directly connected to the dielectric layer 2, thereby reducing the thickness of the circularly polarized antenna along the third direction Z. For example, when the dielectric layer 2 is a glass dielectric layer, a glass-based semiconductor process can be used to prepare the ground layer 1 and the radiating patch 31 on the surface of the dielectric layer 2. For example, when the dielectric layer 2 is a PCB, the ground layer 1 and the radiating patch 31 can be printed on the substrate surface of the PCB.

For example, as shown in FIG. 4, when the dielectric layer 2 is the glass dielectric layer, a first conductive layer 3 can be formed on the first side of the dielectric layer 2 by magnetron sputtering, thermal evaporation, electroplating, etc., and a second conductive layer can be formed on the second side of the dielectric layer 2. The first conductive layer 3 can be patterned to form the radiating patch 31, and the second conductive layer can be used as the ground layer 1 or patterned to form the ground layer 1.

Certainly, the preparation method of the ground layer 1 and the radiating patch 31, the connection method between the ground layer 1 and the dielectric layer 2, as well as the connection method between the radiating patch 31 and the dielectric layer 2, which are not limited in the embodiment of the present disclosure. For example, the ground layer 1 and the radiating patch 31 can be connected to the dielectric layer 2 by bonding.

The thicknesses of the ground layer 1 and the radiating patch 31 can be flexibly set according to actual needs. When the thicknesses of the ground layer 1 and the radiating patch 31 are thick, the loss of the circularly polarized antenna can be reduced. When the thickness of the ground layer 1 and the radiating patch 31 are thin, the size of the circularly polarized antenna can be reduced. In addition, when using the glass-based semiconductor process to prepare the circularly polarized antenna, the difficulty of preparation can be reduced when the thicknesses of the ground layer 1 and the radiating patch 31 are thin.

For example, the thicknesses of the radiating patch 31 and the ground layer 1 are 18-35 μm.

Continuing to refer to FIG. 3, the circularly polarized antenna 100 also includes a power divider module 32, the power divider module 32 includes an input terminal 32a and two output terminals. The power divider module 32 receives the radio frequency current signal through the input terminal 32a and outputs the radio frequency current signals simultaneously through the two output terminals. The amplitude of the output signals of the two output terminals is the same, but the phase difference is 90°. Both the two output terminals are electrically connected to the radiating patch 31, so that the power divider module 32 simultaneously provides two radio frequency current signals with the same amplitude and the phase difference of 90° to the radiating patch 31 through the two output terminals, thus enabling the circularly polarized antenna to achieve circular polarization.

Among them, the power divider module 32 includes two output terminals, which means that the power divider module 32 includes at least two output terminals. The power divider module 32 can also include three output terminals, four output terminals, etc. When the power divider module 32 includes three or more output terminals, only two of the output terminals of the power divider module 32 are electrically connected to the radiating patch 31, and the output signals of the two output terminals electrically connected to the radiating patch 31 have the same amplitude and the phase difference of 90°.

The power divider module 32 is used as a power divider to divide the radio frequency current signal received at the input terminal 32a into two or more radio frequency current signals. The power divider module 32 can be an active device or a passive device. The embodiment of the present disclosure does not limit the structure of the power divider module 32, as long as it can achieve that the output signals of the two output terminals electrically connected to the radiating patch 31 have the same amplitude and the phase difference of 90°.

The radiating patch 31 includes a first feed point 31a and a second feed point 31b. Which are parts of the radiating patch 31 used for being electrically connected to the output terminals of the power divider module 32. The first feed point 31a and the second feed point 31b are arranged at an interval.

For example, when the radiating patch 31 is circular, the first feed point 31a and the second feed point 31b are two spaced points on the circumference of the radiating patch 31. Certainly, the first feed point 31a and the second feed point 31b can also be points inside the circular radiating patch 31.

The first feed point 31a and the second feed point 31b can be arranged at an interval along the first direction X.

The first feed point 31a is electrically connected to one of the two output terminals of the power divider module 32, and the second feed point 31b is electrically connected to the other one of the two output terminals of the power divider module 32. The radio frequency current signals received by the first feed point 31a and the second feed point 31b have the same amplitude and the phase difference of 90°, thereby achieving circular polarization of the antenna.

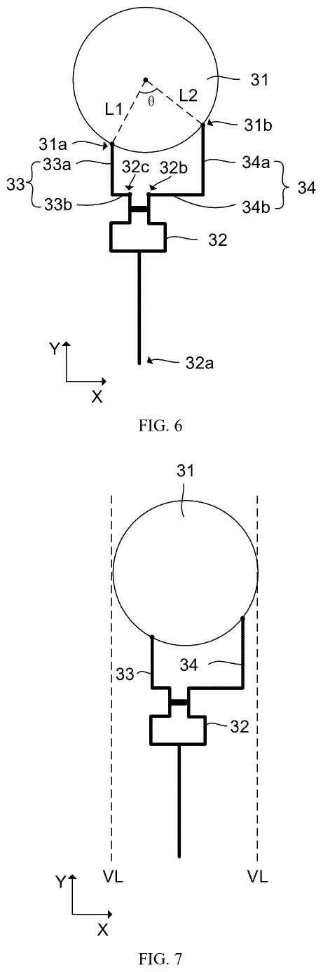

FIG. 6 exemplarily illustrates a partial structural schematic diagram of a circularly polarized antenna. As shown in FIG. 6, a virtual connection line of the first feed point 31a and a center of the radiating patch 31 is regarded as a first line L1, a virtual connection line of the second feed point 31b and the center of the radiating patch 31 is regarded as a second line L2, and an angle between the first line L1 and the second line L2 is less than 90°. That is, the first line L1 and the second line L2 are not orthogonal.

Among them, the first line L1 and the second line L2 are connection lines virtually formed to represent the positional relationship between the first feed point 31a, the second feed point 31b, and the center of the radiating patch 31. The radiating patch 31 may not have physical structures corresponding to the first line L1 and the second line L2.

For example, the radiating patch 31 is a circle, and the center of the radiating patch 31 is the center of the circle. The first line L1 is a radius line passing through the first feed point 31a, and the second line L2 is a radius line passing through the second feed point 31b. The angle between the two radius lines is less than 90°.

For example, the radiating patch 31 is a rectangle, and the center of the radiating patch 31 is the intersegment of the two diagonals of the rectangle.

Due to the angle between the first line L1 and the second line L2 being less than 90°, the distance between the first feed point 31a and the second feed point 31b can be set smaller, that is, the distance between the two output terminals of the power divider module 32 is smaller, thereby making the structure of the circularly polarized antenna more compact. When the first feed point 31a and the second feed point 31b are arranged at an interval along the first direction X, the two output terminals are also arranged at an interval along the first direction X. For example, the two output terminals of the power divider module 32 are located below the radiating patch 31 along the second direction Y, making the size of the circularly polarized antenna along the first direction X smaller.

Among them, in the embodiment of the present disclosure, the radiating patch 31 is taken as an example of a circular patch for illustrative explanation. The radiating patch 31 can also be a polygon such as a triangle, diamond, rectangle, square, trapezoid, etc. The radiating patch 31 can also be an irregular shape, and the embodiment of the present disclosure does not limit the shape of the radiating patch 31.

The circularly polarized antenna provided in the embodiment of the present disclosure includes the first feed point 31a and the second feed point 31b. The first feed point 31a is electrically connected to one of the output terminals, and the second feed point 31b is electrically connected to the other output terminal. The virtual connection line between the first feed point 31a and the center of the radiating patch 31 is the first line L1, and the virtual connection line between the second feed point 31b and the center of the radiating patch 31 is the second line L2. The angle between the first line L1 and the second line L2 is less than 90°. Unlike the circularly polarized antenna 100 in related art that uses orthogonal feeding, the embodiment of the present disclosure utilizes the phase difference between the two output terminals of the power divider module 32 and the different positions of the first feed point 31a1 and the second feed point 31b1, to achieve antenna circular polarization while reducing the size of the antenna along the first direction X.

Continuing to refer to FIG. 6, the power divider module 32 includes a power divider, a first signal line 33 and a second signal line 34; the power divider includes the input terminal 32a, a first output terminal 32c and a second output terminal 32b, the first signal line 33 is electrically connected to the first output terminal 32c and the first feed point 31a, the second signal line 34 is electrically connected to the second output terminal 32b and the second feed point 31b, and lengths of the first signal line 33 and the second signal line 34 are different.

The power divider inputs the radio frequency current signal through the input terminal 32a and outputs the radio frequency current signals through the first output terminal 32c and the second output terminal 32b. The amplitudes and the phases of the radio frequency current signals output from the first output terminal 32c and the second output terminal 32b can be the same.

For example, the power divider can be a Wilkinson power divider or a T-shaped power divider. The embodiment of the present disclosure takes the power divider being the Wilkinson power divider as an example for illustrative explanation. The power divider can also be other types of power dividers, as long as they can output the radio frequency current signals with the same amplitude and phase through the first output terminal 32c and the second output terminal 32b.

When the power divider is the Wilkinson power divider, in order to improve the isolation degree of the first output terminal 32c and the second output terminal 32b, an isolation resistor can be connected between the first output terminal 32c and the second output terminal 32b.

Due to the same phase of the radio frequency current signals output from the first output terminal 32c and the second output terminal 32b, and the different lengths of the first signal line 33 and the second signal line 34, there is a phase difference between the radio frequency current signals fed into the first feed point 31a and the second feed point 31b. Moreover, the magnitude of the phase difference is related to the length difference between the first signal line 33 and the second signal line 34.

For example, the length difference between the first signal line 33 and the second signal line 34 is one fourth of the waveguide wavelength, resulting in the phase difference of 90° between the radio frequency current signals fed into the first feed point 31a and the second feed point 31b.

In practical applications, the axial ratio and circular polarization performance of the circularly polarized antenna can be adjusted by adjusting the lengths of the first signal line 33 and the second signal line 34, as well as the distance between the first feed point 31a and the second feed point 31b.

For example, the distance between the first feed point 31a and the second feed point 31b is 4.9~5.9 mm.

For example, the length difference between the first signal line 33 and the second signal line 34 is 2.8~3.8 mm. When the length difference between the first signal line 33 and the second signal line 34 is about 3.3 mm, the circularly polarized antenna can achieve good axial ratio and circular polarization performance. However, when the deviation of the length difference between the first signal line 33 and the second signal line 34 from 3.3 mm is greater than or less than 0.5 mm, the axial ratio and the circular polarization performance deteriorate.

Among them, the length of the first signal line 33 can be smaller than the length of the second signal line 34, so that the radiating patch 31 excites right-handed circular radiation. The length of the first signal line 33 can also be greater than the length of the second signal line 34, so that the radiating patch 31 excites left-handed circular radiation.

The radiating patch 31, the power divider, the first signal line 33, and the second signal line 34 can be arranged on the same layer, reducing the number of film layers of the circularly polarized antenna and making the thickness of the circularly polarized antenna along the third direction Z thinner, resulting in a more compact structure of the circularly polarized antenna. For example, the radiating patch 31, the power divider, the first signal line 33, and the second signal line 34 are all located in the first conductive layer 3.

For example, the radiating patch 31, the power divider, the first signal line 33, and the second signal line 34 are formed in the same patterning process, which can reduce the preparation process steps of the circularly polarized antenna. After forming the first conductive layer 3 on the first side of the dielectric layer 2 through the magnetron sputtering, the thermal evaporation, the electroplating, etc., the first conductive layer 3 is patterned to form the radiating patch 31, the power divider, the first signal line 33, and the second signal line 34.

Among them, when the power divider is the Wilkinson power divider, the wirings of the Wilkinson power divider are located on the first conductive layer 3, and the isolation resistor of the Wilkinson power divider can be connected between the first output terminal 32c and the second output terminal 32b by welding.

Certainly, the radiating patch 31, the power divider, the first signal line 33, and the second signal line 34 can also be located on different conductive layers. For example, the circularly polarized antenna also includes a third conductive layer located on the side of the first conductive layer 3 away from the dielectric layer 2, and at least one of the power divider, the first signal line 33, and the second signal line 34 may be located on the third conductive layer.

FIG. 7 exemplarily illustrates a partial structure of a circularly polarized antenna. As shown in FIG. 7, when the radiating patch 31, the power divider, the first signal line 33, and the second signal line 34 are all located on the first conductive layer, the first conductive layer 3 has two virtual straight lines VL that are parallel and arranged at an interval, the radiating patch 31 is connected to the two virtual straight lines VL, and the radiating patch 31, the first signal line 33, the second signal line 34 and the power divider are located between the two virtual straight lines VL.

Among them, the two virtual straight lines VL are straight lines virtually formed to represent the relative sizes of the power divider, the first signal line 33, the second signal line 34, and the radiating patch 31 along the first direction X. The first conductive layer 3 may not have physical structures corresponding to the two virtual straight lines VL.

For example, the two virtual straight lines VL extend along the second direction Y, with one virtual straight line VL connected to the leftmost edge of the radiating patch 31 along the first direction X, and the other virtual straight line VL connected to the rightmost edge of the radiating patch 31 along the first direction X. When the radiating patch 31, the first signal line 33, the second signal line 34, and the power divider are located between the two virtual straight lines VL, the sizes of the radiating patch 31, the first signal line 33, the second signal line 34, and the power divider along the first direction X are all smaller than a distance between the two virtual straight lines VL, that is, along the first direction X, the sizes of the first signal line 33, the second signal line 34, and the power divider are all smaller than the size of the radiating patch 31.

For example, as shown in FIG. 6, the radiating patch 31 is a circular patch, and the two spaced virtual straight lines VL extend along the second direction Y. One virtual straight line VL is tangent to the left edge of the radiating patch 31, and the other virtual straight line VL is tangent to the right edge of the radiating patch 31. The first signal line 33, the second signal line 34, and the power divider are all located between the two virtual straight lines VL.

That is to say, the sizes of the first signal line 33, the second signal line 34, and the power divider in the first direction X are all smaller than the size of the radiating patch 31, making the circularly polarized antenna smaller in size along the first direction X and more compact in structure.

At this point, the radiating patch 31, the first signal line 33, the second signal line 34, and the power divider can be arranged in sequence along the second direction Y. That is, the first signal line 33 and the second signal line 34 are located between the radiating patch 31 and the power divider.

It can be understood that when the radiating patch 31 is a rectangle, the rectangle includes two edges extending along the second direction Y, and the extension lines of these two edges extending along the second direction Y can be used as the two virtual straight lines VL. The same applies to other shapes of the radiating patch 31, which are not listed here.

In addition, the two virtual straight lines VL can also form a certain angle with the second direction Y. For example, the angles between the two virtual straight lines VL and the second direction Y are 80°, 70°, 60°, etc.

Continuing to refer to FIG. 6, the first signal line 33 includes a first feed segment 33a, the first feed segment 33a is electrically connected to the first feed point 31a, the second signal line 34 includes a second feed segment 34a, the second feed segment 34a is electrically connected to the second feed point 31b, and the first feed segment 33a and the second feed segment 34a are parallel and arranged at an interval. Compared to the cross arrangement of the first feed segment 33a and the second feed segment 34a, the structure of the circularly polarized antenna is more compact when the first feed segment 33a and the second feed segment 34a are arranged in parallel.

For example, one end of the first feed segment 33a is electrically connected to the first feed point 31a, and the other end of the first feed segment 33a is electrically connected to the first output terminal 32c. One end of the second feed segment 34a is electrically connected to the second feed point 31b, and the other end of the second feed segment 34a is electrically connected to the second output terminal 32b.

For example, the first feed segment 33a and the second feed segment 34a extend along the second direction Y. Certainly, the first feed segment 33a and the second feed segment 34a can also form a certain angle with the second direction Y. For example, the angle between the first feed segment 33a and the second direction Y, and the angle between the second feed segment 34a and the second direction Y are 80°, 70°, 60°, etc.

Certainly, the first feed segment 33a can also extend along the direction of the first line L1, and the second feed segment 34a can extend along the direction of the second line L2.

Continuing to refer to FIG. 6, the first signal line 33 also includes a first connection segment 33b, which electrically connects the first feed segment 33a and the first output terminal 32c; the second signal line 34 also includes a second connection segment 34b, which electrically connects the second feed segment 34a and the second output terminal 32b. The length of the first signal line 33 is the sum of the lengths of the first feed segment 33a and the first connection segment 33b, and the length of the second signal line 34 is the sum of the lengths of the second feed segment 34a and the second connection segment 34b.

For example, the first connection segment 33b and the second connection segment 34b extend along the first direction X.

Among them, the lengths of the first signal line 33 and the second signal line 34 are different, specifically, the lengths of the first connection segment 33b and the second connection segment 34b are equal, and the lengths of the first feed segment 33a and the second feed segment 34a are different. The lengths of the first signal line 33 and the second signal line 34 are different, specifically, the lengths of the first connection segment 33b and the second connection segment 34b are different, and the lengths of the first feed segment 33a and the second feed segment 34a are different.

One radiating patch 31, a ground layer 1 arranged opposite to the radiating patch 31, a dielectric layer 2 located between the radiating patch 31 and the ground layer 1, and a power divider module 32 electrically connected to the radiating patch 31 together constitute an antenna unit. The circularly polarized antenna can include one antenna unit or a plurality of antenna units. When the circularly polarized antenna includes one antenna unit, it is a single beam circularly polarized antenna.

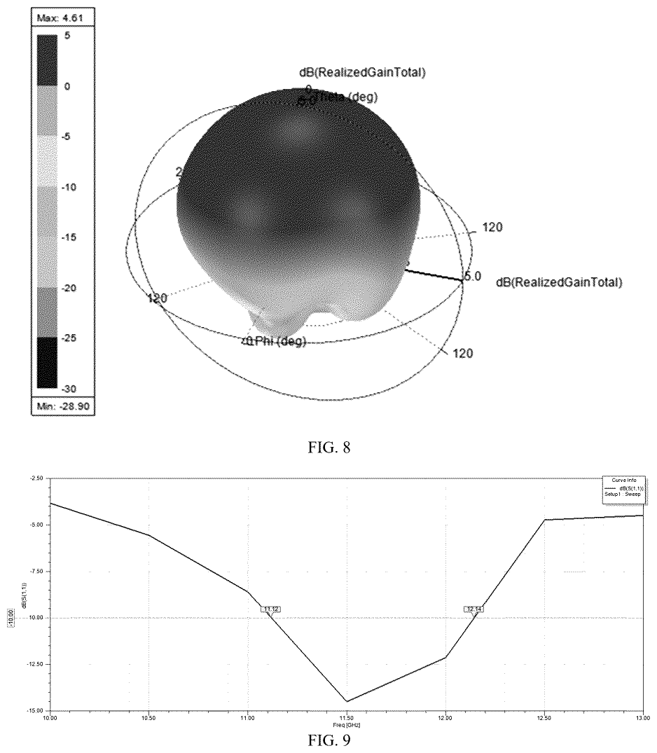

FIG. 8 shows the 3D directional diagram of the circularly polarized antenna shown in FIG. 3. Among them, the circularly polarized antenna can be applied to satellite communication scenarios in a KU band. The KU band refers to a band with a lower frequency than the K-band under the IEEE 521-2002 standard. The frequency band of KU usually ranges from 10.7 to 12.75 GHz in the downlink and ranges from 12.75 to 18.1 GHz in the uplink. The single repeater power of KU band satellites is generally larger, and shaped beam coverage is often used. The satellite EIRP is larger, and the efficiency of KU band receiving antennas is higher than that of C-band receiving antennas. Therefore, the antenna aperture for receiving KU band satellite programs is much smaller than that for C-band, which can effectively reduce reception costs and facilitate individual reception. FIG. 8 shows the gain graph at 12 GHz. It can be seen from FIG. 8 that the circularly polarized antenna provided in the embodiment of the present disclosure has good gain performance at 12 GHz, with a maximum realized gain of approximately 4.61 dBi.

FIG. 9 shows an input impedance bandwidth diagram of the circularly polarized antenna shown in FIG. 3, that is, the S11 curve diagram of the circularly polarized antenna shown in FIG. 3. The horizontal axis in FIG. 9 represents the frequency, and the vertical axis represents the gain. From FIG. 9, it can be seen that, for the circularly polarized antenna 100 of the embodiment of the present disclosure, when operating at the frequency ranging from 11.12 GHz to 12.14 GHz, S11≤−10 dB, it has a good impedance bandwidth. In practical applications, impedance matching can be achieved by setting the widths of the first signal line 33 and the second signal line 34, as well as the width of the feeder line.

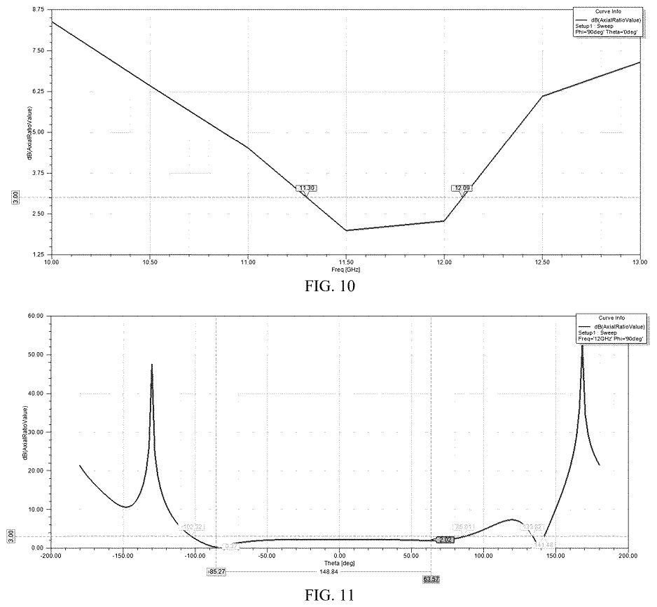

The axial ratio of the circularly polarized antenna is an important parameter for determining its performance, and it is generally necessary to control the axial ratio less than 3 dB when designing the circularly polarized antenna. FIG. 10 illustrates a curve of an axial ratio of the circularly polarized antenna shown in FIG. 3 varies with the frequency. The horizontal axis in FIG. 10 represents the frequency, and the vertical axis represents the gain. As shown in FIG. 10, the circularly polarized antenna of the embodiment of the present disclosure has the axial ratio of less than 3 dB at the frequency ranging from 11.30 GHz to 12.09 GHz, indicating good circularly polarized performance.

FIG. 11 illustrates a diagram of the axial ratio of the circularly polarized antenna shown in FIG. 3 varies with Theta in FIG. 8. The horizontal axis in FIG. 11 represents the angle Theta, and the vertical axis represents the gain. As shown in FIG. 11, Theta has an axial ratio of less than 3 dB within the range of −102° to 86°, demonstrating excellent circular polarization performance.

From FIG. 8 to FIG. 11, it can be seen that the circularly polarized antenna provided in the embodiment of the present disclosure has good gain performance and circular polarization performance, and is easy to achieve impedance matching.

With the development of mobile communication technology, the number of the communication terminals is rapidly increasing. In related art, channel capacity is usually increased by increasing the carrier frequency, the carrier channel and adding base stations. However, even with the increasing density and higher configuration of the base stations, network congestion still occurs. In view of this, a solution can be proposed from the perspective of the antenna feeder link, which is to use a dual beam circularly polarized antenna. The dual beam circularly polarized antenna generates two beams, which can not only increase the channel capacity and the coverage range, but also improve stability and reliability of the system. For example, if one beam of the dual beam circularly polarized antenna is lost, the other beam can still continue to work. When the circularly polarized antenna are applied to the communication terminals in satellite communication links, the dual beam circularly polarized antennas can reduce the probability of satellite loss and improve the reliability of satellite communication.

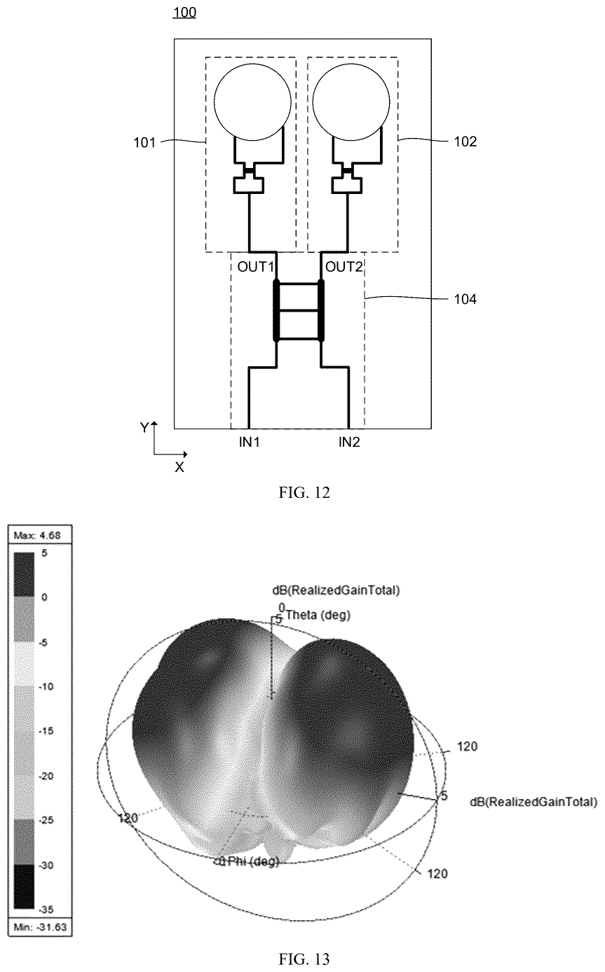

FIG. 12 exemplarily illustrates a front view of another circularly polarized antenna. As shown in FIG. 12, in order to generate two beams for the circularly polarized antenna 100, the circularly polarized antenna 100 may include a plurality of antenna units, for example, the circularly polarized antenna 100 includes two antenna units. The two antenna units include a first antenna unit 101 and a second antenna unit 102. During operation, the first antenna unit 101 generates one beam and the second antenna unit 102 generates another beam.

Among them, the circular polarized antenna 100 includes two antenna units, which means that the circular polarized antenna 100 includes at least two antenna units. The circular polarized antenna 100 can also include three antenna units, four antenna units, etc.

Continuing to refer to FIG. 12, the circularly polarized antenna 100 further includes a branch-line coupler 104, which includes a first input port IN1, a second input port IN2, a first output port OUT1, and a second output port OUT2. The first output port OUT1 is electrically connected to the input terminal 32a of the first antenna unit 101, and the second output port OUT2 is electrically connected to the input terminal 32a of the second antenna unit 102.

Among them, the branch-line coupler 104 receives the radio frequency current signals through the first input port IN1 and the second input port IN2, and outputs the radio frequency signals through the first output port OUT1 and the second output port OUT2, and the phase difference between the signals output from the first output port OUT1 and the second output port OUT2 is 90°.

The branch-line coupler 104 is a microwave device with a plurality of input ports and a plurality of output ports. The phase difference between the two output ports of the branch-line coupler 104 is 90°, also known as branch-line bridge, commonly used for power distribution and synthesis.

For example, the branch-line coupler 104 is a Butler matrix or a 3 dB bridge. Certainly, the embodiment of the present disclosure does not limit the type of the branch-line coupler 104, as long as the phase difference between the radio frequency current signals output from the first output port OUT1 and the second output port OUT2 of the branch-line coupler 104 is 90°.

Continuing to refer to FIG. 12, the first antenna unit 101 and the second antenna unit 102 can be arranged at intervals along the first direction X. When the circularly polarized antenna 100 is in operation, the branch-line coupler 104 outputs a first radio frequency signal to the first antenna unit 101 through the first output port OUT1, and outputs a second radio frequency signal to the second antenna unit 102 through the second output port OUT2. The phase difference between the first radio frequency signal and the second radio frequency signal is 90°. The first antenna unit 101 radiates electromagnetic waves outward under the excitation of the first radio frequency signal to form one beam, and the second antenna unit 102 radiates the electromagnetic waves outward under the excitation of the second radio frequency signal to form another beam, thereby causing the circularly polarized antenna 100 to form two beams, reducing the probability of satellite loss and improving the reliability of satellite communication.

FIG. 13 shows the 3D directional diagram of the circularly polarized antenna 100 shown in FIG. 12. Among them, the circularly polarized antenna 100 can be applied to satellite communication scenarios in the KU band, so FIG. 13 shows the gain graph at 12 GHz. As shown in FIG. 13, the circularly polarized antenna 100 provided in the embodiment of the present disclosure includes two beams, with a maximum realized gain of approximately 4.68 dBi. For example, two beams are deflected by 30° relative to the normal direction, that is, the angle between the two beams is 60°. For example, the normal direction is the vertical direction in FIG. 13, where one beam is deflected 30° to the left side relative to the normal direction, and the other beam is deflected 30° to the right side relative to the normal direction, so that the angle between the two beams is 60°.

FIG. 14 shows the input impedance bandwidth diagram of the circularly polarized antenna 100 shown in FIG. 12, i.e., the S11 curve diagram of the circularly polarized antenna 100 shown in FIG. 12. The horizontal axis in FIG. 14 represents the frequency, and the vertical axis represents the gain. From FIG. 14, it can be seen that, for the circularly polarized antenna 100 of the embodiment of the present disclosure, when operating at the frequency ranging from 10.55 GHz to 16 GHz, S11≤−10 dB, an absolute bandwidth is greater than 5.45 GHz, and a relative bandwidth ratio is about 41%, with good impedance bandwidth. Compared to the circularly polarized antenna 100 shown in FIG. 3, the antenna shown in FIG. 12 has a wider bandwidth. In practical applications, the impedance matching can be achieved by setting the widths of the first signal line 33 and the second signal line 34, as well as the width of the feeder line.

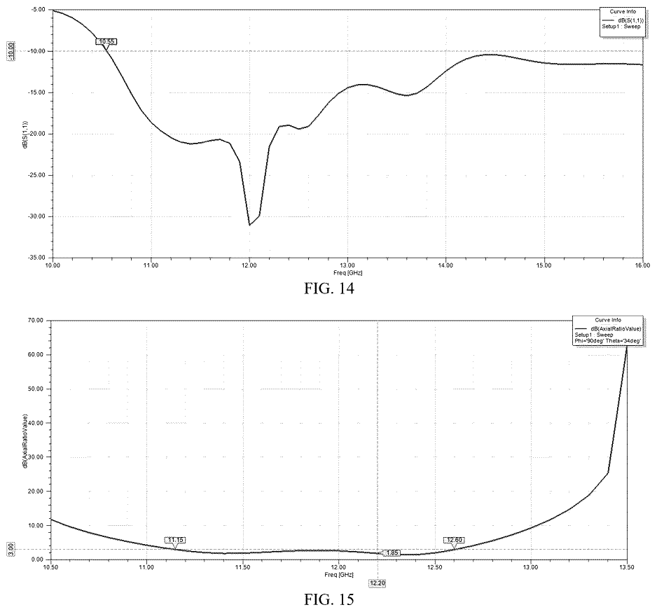

The axial ratio of the circularly polarized antenna 100 is an important parameter for determining its circularly polarized performance, and it is generally necessary to control the axial ratio less than 3 dB when designing the circularly polarized antenna 100. FIG. 15 illustrates a curve of an axial ratio of the circularly polarized antenna 100 shown in FIG. 12 varies with the frequency. In FIG. 15, the horizontal axis represents frequency and the vertical axis represents gain. As shown in FIG. 15, the axial ratio of the circularly polarized antenna 100 in the embodiment of the present disclosure is less than 3 dB at 11.15~12.6 GHz, indicating better circularly polarized performance compared to the circularly polarized antenna 100 shown in FIG. 3.

From FIG. 13 to FIG. 15, it can be seen that by setting up a branch-line coupler 104, and antenna units connecting to two output ports of the branch-line coupler 104, the circularly polarized antenna 100 can form two beams. When one beam is lost, the other beam can still continue to work, improving the reliability of communication. Moreover, the impedance bandwidth of the circularly polarized antenna 100 is expanded, and the axial ratio performance of the circularly polarized antenna is optimized.

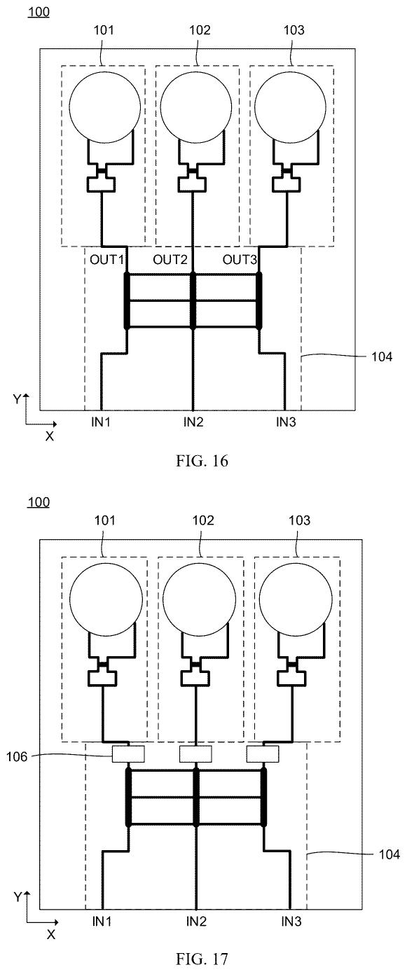

FIG. 16 exemplarily illustrates a front view of another circularly polarized antenna 100. As shown in FIG. 16, a plurality of antenna units can include three antenna units. The three antenna units include a first antenna unit 101, a second antenna unit 102, and a third antenna unit 103. The branch-line coupler 104 includes a first input port IN1, a second input port IN2, a third input port IN3, a first output port OUT1, a second output port OUT2, and a third output port OUT3. The first output port OUT1 is electrically connected to the input terminal 32a of the first antenna unit 101, the second output port OUT2 is electrically connected to the input terminal 32a of the second antenna unit 102, and the third output port OUT3 is electrically connected to the input terminal 32a of the third antenna unit 103.

Among them, the circularly polarized antenna 100 includes three antenna units, which means that the circularly polarized antenna 100 includes at least three antenna units. The circularly polarized antenna 100 can also include four antenna units, five antenna units, six antenna units, etc.

The branch-line coupler 104 receives radio frequency signals through the first input port IN1, the second input port IN2, and the third input port IN3, and outputs the radio frequency signals through the first output port OUT1, the second output port OUT2, and the third output port OUT3. The signals output from the first output port OUT1, the second output port OUT2, and the third output port OUT3 have a phase difference of 90° in sequence.

For example, the branch-line coupler 104 is a three-in three-out Butler matrix. Certainly, this embodiment of the present disclosure does not limit the type of the branch-line coupler 104, as long as the signal output from the first output port OUT1, the second output port OUT2, and the third output port OUT3 of the branch-line coupler 104 have a phase difference of 90° in sequence.

Continuing to refer to FIG. 16, the first antenna unit 101, the second antenna unit 102, and the third antenna unit 103 can be arranged at intervals along the first direction X. When the circularly polarized antenna 100 works, the branch-line coupler 104 outputs a first radio frequency signal to the first antenna unit 101 through the first output port OUT1, outputs a second radio frequency signal to the second antenna unit 102 through the second output port OUT2, and outputs a third radio frequency signal to the third antenna unit 103 through the third output port OUT3. The phases of the first radio frequency signal, the second radio frequency signal, and the third radio frequency signal differ by 90° in sequence, and the first antenna unit 101, the second antenna unit 102, and the third antenna unit 103 simultaneously radiate electromagnetic waves outward. The branch-line coupler 104 is electrically connected to three antenna units, which can enhance the signal strength.

FIG. 17 exemplarily illustrates the structure of another circularly polarized antenna 100. As shown in FIG. 17, a filter 106 may be connected between the output port of the branch-line coupler 104 and the input terminal 32a of the antenna unit. The filter 106 can filter signals within a specific frequency and/or phase range while receiving or transmitting the electromagnetic waves by the circularly polarized antenna 100, thereby playing a role in signal selection and interference suppression, improving the performance and reliability of the system. The embodiment of the present disclosure does not limit the structure of the filter 106, as long as it can filter out signals with partial phases to solve the problem of phase mixing.

The filter 106 solves the problem of phase mixing by filtering signals within the specific frequency and/or phase range, for example, the filter filters signals with partial phases to solve the problem of phase mixing.

The filter 106 can be placed on the same layer as the radiating patch 31, the first signal line 33, the second signal line 34, and the power divider, thereby reducing the number of film layers of the circularly polarized antenna 100 and decreasing the thickness of the circularly polarized antenna 100 along the third direction Z.

For example, the radiating patch 31, the first signal line 33, the second signal line 34, the power divider, and the filter 106 are all located in the first conductive layer 3. For example, after forming the first conductive layer 3 on the first side of the dielectric layer 2 through magnetron sputtering, thermal evaporation, electroplating, etc., the first conductive layer 3 is patterned to form the radiating patch 31, the power divider, the first signal line 33, the second signal line 34, and the filter 106.

Continuing to refer to FIG. 12 and FIG. 16, two adjacent radiating patches 31 are arranged at an interval, and a distance between centers of the two adjacent radiating patches 31 is half of a spatial wavelength.

For example, when the radiating patch 31 is a circle, the distance between two adjacent radiating patches 31 is the distance between the centers of the circle of the two adjacent radiating patches 31.

For example, when the radiating patch 31 is a rectangle and other polygons, the distance between two adjacent radiating patches 31 is the distance between the geometric centers of the two adjacent radiating patches 31.

Among them, the two adjacent radiating patches 31 arranging at intervals does not refer to that the two adjacent radiating patches 31 are disconnected, but rather to that there is a gap between the main structures of the two adjacent radiating patches 31. The two adjacent radiating patches 31 can be disconnected or connected through connecting wires.

When the circularly polarized antenna 100 includes the plurality of antenna units, there is significant spatial coupling between the plurality of antenna units. For example, when the structure of the circularly polarized antenna 100 is as shown in FIG. 12, FIG. 16, and FIG. 17, there is significant spatial coupling between different antenna units in the circularly polarized antenna 100, resulting in low isolation degree of the two adjacent antenna units. In view of this, an isolation structure can be provided between the radiating patches 31 of the two adjacent antenna units to improve the isolation degree of the two adjacent antenna units.

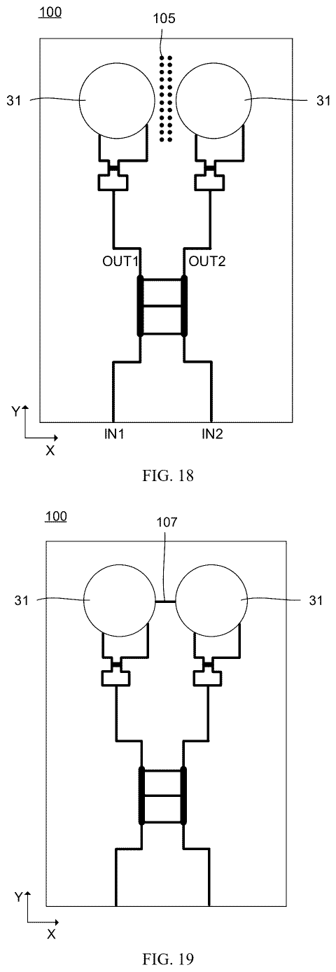

FIG. 18 exemplarily illustrates the structure of another circularly polarized antenna 100. As shown in FIG. 18, a plurality of conductive pillars 105 are provided between the two adjacent radiating patches 31, and an axial direction of each of the plurality of conductive pillars 105 is perpendicular to the ground layer 1. By setting the plurality of conductive pillars 105, the isolation degree of different antenna units can be increased.

Among them, the axis of the conductive pillar 105 being perpendicular to the ground layer 1 does not mean that the axis is strictly perpendicular to the ground layer 1, but it means that the axis of the conductive pillar 105 roughly extends along the thickness direction of the dielectric layer 2.

For example, the plurality of conductive pillars 105 are arranged in an array, forming multiple conductive pillar columns. The plurality of conductive pillars 105 in the same conductive pillar column are arranged at an interval along the extension direction (such as the second direction Y) of the gap between adjacent radiating patches 31, and multiple conductive pillar columns are arranged at an interval along the first direction X.

Among them, the conductive pillars 105 in different conductive pillar columns can be staggered at a certain distance along the second direction Y.

The orthographic projections of the radiating patches 31 on the conductive pillar columns are located within the range of the conductive pillar columns to improve the isolation degree of different antenna units. For example, the upper end of the conductive pillar column protrudes from the radiating patch 31 along the second direction Y, and the lower end of the conductive pillar column also protrudes from the radiating patch 31 along the second direction Y.

The first end of the conductive pillar 105 can be located between two adjacent radiating patches 31, and the second end of the conductive pillar 105 can be spaced apart from the ground layer 1, that is, the conductive pillar 105 is not connected to the ground layer 1.

Among them, along the third direction Z, the first end of the conductive pillar 105 can be flush with the radiating patch 31, can protrude from the radiating patch 31, or can be lower than the radiating patch 31.

At least a portion of the structure of the conductive pillar 105 can be located within the dielectric layer 2 to reduce the thickness of the circularly polarized antenna 100 along the third direction Z. For example, the dielectric layer 2 can have a plurality of openings, and the conductive pillar 105 is arranged inside the openings.

For example, the dielectric layer 2 is a glass dielectric layer 2, and the plurality of openings are opened on the glass dielectric layer 2 through the etching process. Then, the metal material is deposited inside the openings to form the conductive pillars 105. At this point, the first ends of the conductive pillars 105 are flush with the dielectric layer 2.

FIG. 19 exemplarily illustrates the structure of another circularly polarized antenna 100. As shown in FIG. 19, a neutralization line 107 is provided between the two adjacent radiating patches 31, one end of the neutralization line 107 is electrically connected to one of the two adjacent radiating patches 31, and the other end of the neutralization line 107 is electrically connected to the other one of the two adjacent radiating patches 31.

The neutralization line 107 can be arranged on the same layer as the radiating patch 31, the first signal line 33, the second signal line 34, the power divider, and the branch-line coupler 104, to reduce the number of film layers of the circularly polarized antenna 100 and reduce the thickness of the circularly polarized antenna 100 along the third direction Z.

For example, the radiating patch 31, the first signal line 33, the second signal line 34, the power divider, the branch-line coupler 104, and the neutralization line 107 are all located within the first conductive layer 3, that is, the radiating patch 31, the first signal line 33, the second signal line 34, the power divider, the branch-line coupler 104, and the neutralization line 107 are formed in one graphic process.

Certainly, the neutralization line 107 can also be connected between two radiating patches 31 by welding. For example, the neutralization line 107 is a zero ohm resistor, one end of the zero ohm resistor is welded to one radiating patch 31, and the other end of the zero ohm resistor is welded to another radiating patch 31.

In addition, the circularly polarized antenna 100 can be provided with the conductive pillars 105 and the neutralization line 107 simultaneously to increase the isolation degree of the two adjacent radiating patches 31.

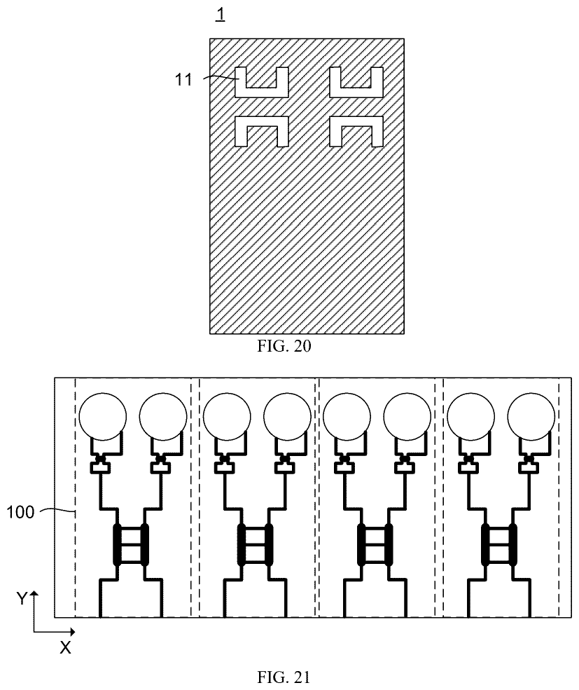

FIG. 20 exemplarily illustrates a structure of a grounding layer 1. As shown in FIG. 20, the ground layer 1 is provided with a defective ground structure 11. By setting up a defective ground structure 11, the isolation degree of different antenna units can be increased. FIG. 20 shows one defective ground structure 11. In practical applications, the defective ground structure 11 can also be of different types. The specific structure of the defective ground structure 11 is not limited in the embodiment of the present disclosure.

In addition, the circularly polarized antennas can be provided with the conductive pillars 105, the neutralization line 107, and the defective ground structure 11 simultaneously, or only with the conductive pillars 105 and the defective ground structure 11, or only with the neutralization line 107 and the defective ground structure 11.

The embodiment of the present disclosure also provides an array antenna, the array antenna includes a plurality of circularly polarized antennas 100, the plurality of circularly polarized antennas 100 are arranged in an array. The plurality of circularly polarized antennas 100 are arranged in an array to increase the gain of the array antenna. The communication terminal provided in the embodiment of the present disclosure may include the circularly polarized antenna 100 described above, or include the array antenna, or include both the circularly polarized antenna 100 and the array antenna. For example, the communication terminal includes two antennas, one of which is the circularly polarized antenna and the other is the array antenna.

The number of the circularly polarized antennas 100 in the array antenna can be four, eight, sixteen, etc. The embodiment of the present disclosure does not limit the number of the circularly polarized antennas 100, as long as the plurality of circularly polarized antennas 100 form the antenna array.

For the convenience of description, the composition and arrangement of the array antenna will be similarly explained by taking the array antenna including four circularly polarized antennas 100 as an example.

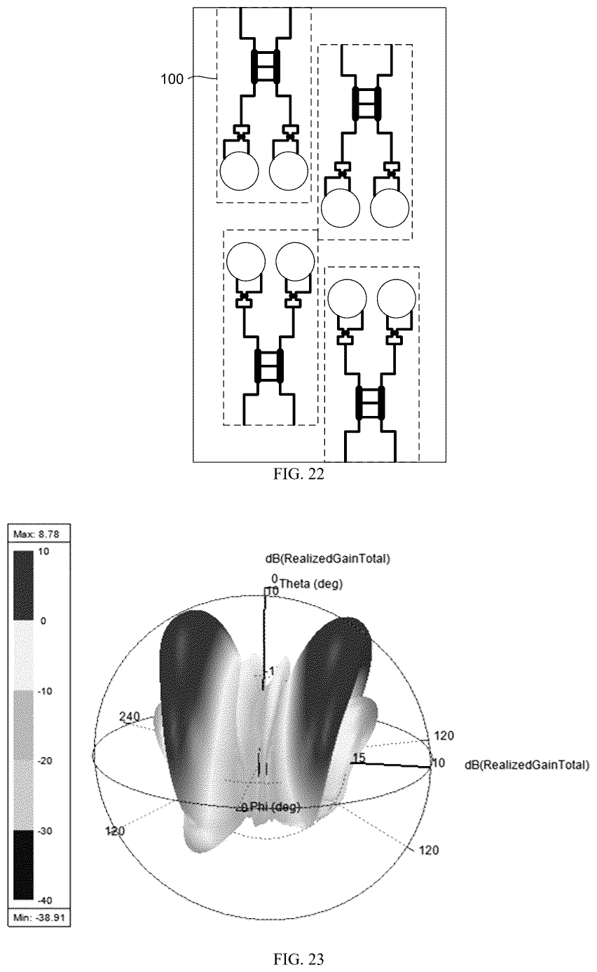

FIG. 21 exemplarily illustrates the structure of an array antenna, and FIG. 22 exemplarily illustrates the structure of an array antenna. FIG. 21 and FIG. 22 illustrate the arrangement of four circularly polarized antennas 100 when the array antenna includes four circularly polarized antennas.

As shown in FIG. 21, the four circularly polarized antennas 100 can be arranged at intervals along the first direction X, that is, eight radiating patches 31 are arranged in a 1*8 array. Among them, 1*8 refers to the antenna array including a row of radiating patches 31, each row of radiating patches 31 includes eight radiating patches 31, that is, the number before the symbol * represents the number of rows, and the number after the symbol * represents the number of the radiating patches 31 included in each row of the radiating patches 31. During operation, the phase difference of the radio frequency signals fed between two adjacent input ports of the branch-line coupler 104 can be −180°. For example, in the direction from left to right as shown in the diagram, with the phase of the first input port as the reference, the phase of the second input port is 180° later than that of the first input port, the phase of the third input port is 180° later than that of the second input port, and so on.

FIG. 23 shows the 3D directional diagram of the array antenna shown in FIG. 20. As shown in FIG. 23, compared to a single circularly polarized antenna 100, after the plurality of circularly polarized antennas 100 form an array, the gain of the array antenna is improved.

Certainly, the four circularly polarized antennas 100 can also be arranged in a 2*2 array configuration, that is, the array antenna includes two rows of antenna units, and each row of antenna units includes two antenna units. As shown in FIG. 22, when the four circularly polarized antennas 100 are arranged in the 2*2 array configuration, they can also be staggered at a certain distance from each other. For example, the plurality of antenna units are arranged in an array to form multiple rows of antenna units, the plurality of antenna units in each row are arranged at an interval along the first direction X, and two adjacent antenna units in the same row are staggered at a certain distance along the second direction Y.

For example, the plurality of antenna units are arranged in an array to form a first antenna unit column and a second antenna unit column. The radiating patch 31 in the first antenna unit column is projected in the second direction Y as the first projection, and the radiating patch 31 in the second antenna unit column is projected in the second direction Y as the second projection, and the second projection is located between two adjacent first projections.

The two adjacent antenna units in the same row are staggered at a certain distance along the second direction Y, making the arrangement of the plurality of radiating patches 31 in the array antenna more compact and reducing the size of the array antenna.

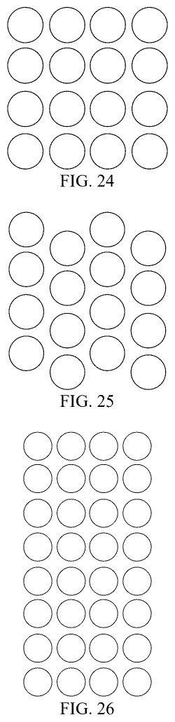

FIG. 24 exemplarily illustrates the structural diagram of another array antenna, and FIG. 25 exemplarily illustrates the structural diagram of another array antenna. In the figure, one circle represents the radiating patch 31 in one circularly polarized antenna 100. To simplify the representation, the power divider module 32, the branch-line coupler 104, the ground layer 1, and the dielectric layer 2 are not shown in the figure. FIG. 24 and FIG. 25 illustrate the arrangement of the circularly polarized antenna 100 taking the array antenna including eight circularly polarized antennas 100 as an example.

As shown in FIG. 24, the eight circularly polarized antennas 100 include sixteen radiating patches 31, which can be arranged in a 4*4 array configuration.

As shown in FIG. 25, the sixteen radiating patches 31 are arranged in the 4*4 array configuration to form a plurality of radiating patch columns. Each radiating patch column includes four radiating patches 31 arranged along the second direction Y, and two adjacent radiating patch columns are staggered at a certain distance along the second direction Y.

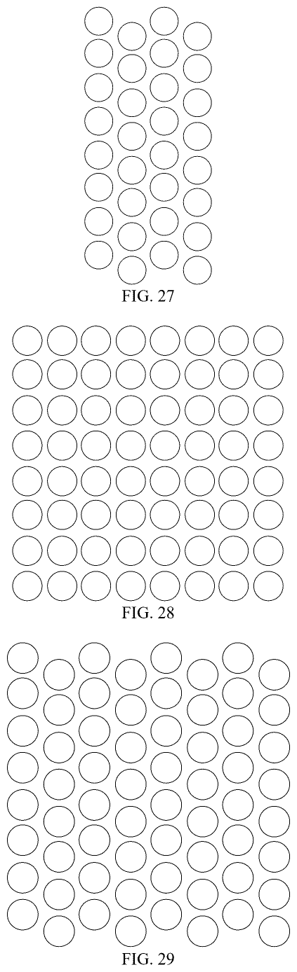

Similarly, when the array antenna includes the sixteen circularly polarized antennas 100, the array antenna can include thirty-two radiating patches 31, which can be arranged in an 8*4 array configuration, forming eight rows of radiating patches 31, each row of radiating patches 31 including four radiating patches 31, as shown in FIG. 26. As shown in FIG. 27, the two adjacent radiating patch columns can be staggered at a certain distance along the second direction Y.

As shown in FIG. 28, the array antenna can also include thirty-two circularly polarized antennas 100, which includes sixty-four radiating patches 31 arranged in an 8*8 array configuration. As shown in FIG. 29, the two adjacent radiating patch columns can be staggered at a certain distance along the second direction Y.

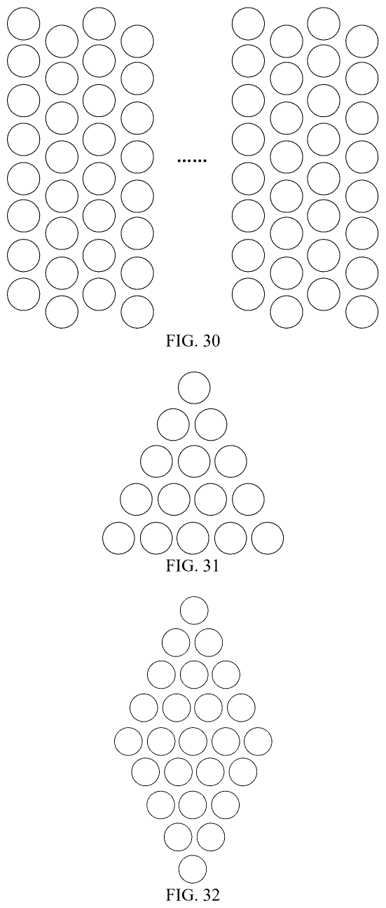

Certainly, the number of radiating patches 31 inside the array antenna is not limited to this. As shown in FIG. 30, the radiating patches 31 can also be arranged in an 8*n array, where n is an even number greater than 8.

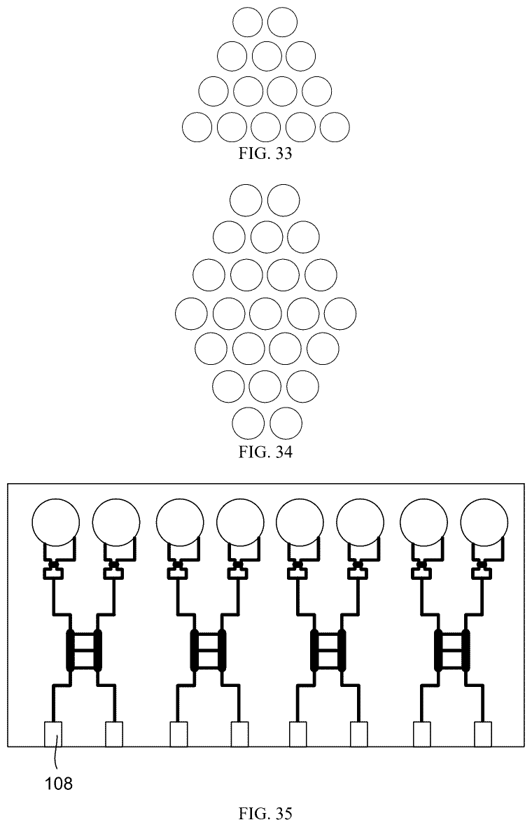

FIG. 31 to FIG. 34 exemplarily illustrate other arrangements of the radiating patches 31. As shown in FIG. 31, the plurality of radiating patches 31 within the array antenna can be arranged in a triangular shape. As shown in FIG. 31, the plurality of radiating patches 31 within the array antenna can be arranged in a diamond shape. As shown in FIG. 32, diamond shape radiating patches 31 within the array antenna can be arranged in a trapezoidal pattern. As shown in FIG. 33, diamond shape radiating patches 31 within the array antenna can be arranged in a hexagonal pattern.

Since the branch-line coupler 104 can only form a fixed phase difference, the array antenna can only achieve a fixed beam direction. In view of this, the array antenna may also include a phase shifter 108, which is configured to adjust the phase of the radio frequency signal. After setting the phase shifter 108, continuous adjustment of the phase of the radio frequency signal can be achieved, thereby achieving beam pointing in different directions.

The phase shifter 108 can be a liquid crystal phase shifter. The liquid crystal phase shifter is a programmable optical phased array using liquid crystal as the electro-optic material. When a periodic voltage is applied to the electrodes of the liquid crystal phase shifter, the liquid crystal in the electrode area forms a periodic phase distribution due to the electro-optic properties of the liquid crystal. The periodic distribution of the phase modulates the phases of signals transmitted in the array to achieve the function of adjusting the phase. The liquid crystal phase shifters use the voltage to control phase changes, with no mechanical rotating parts, small size, and low power consumption. The embodiment of the present disclosure does not limit the type of the phase shifter 108, as long as it can adjust the phase of the radio frequency signal.

For example, the liquid crystal phase shifter sequentially includes a first substrate, a first electrode layer, a liquid crystal layer, a second electrode layer, and a second substrate along the second direction Y. During operation, an electric field is formed between the first electrode layer and the second electrode layer, which drives the motion of the liquid crystal layer, to adjust the phase of the radio frequency signal.

The liquid crystal phase shifter can be integrated with the circularly polarized antenna 100, further reducing the size of the array antenna. For example, the dielectric layer 2 can serve as one of the first substrate or the second substrate of the liquid crystal phase shifter.

Certainly, the liquid crystal phase shifter can also be used as a separate device to achieve electrical connection between the liquid crystal phase shifter and the circularly polarized antenna 100 through the connecting wires.

FIG. 35 exemplarily illustrates the structural diagram of another array antenna. As shown in FIG. 35, the phase shifter 108 can be connected to the input port of the circularly polarized antenna 100, which is the input port of the branch-line coupler 104.

FIG. 36 shows the beam directions corresponding to different phase differences of the array antenna shown in FIG. 35, where the horizontal axis represents Theta and the vertical axis represents gain. As shown in FIG. 36, changing the phase difference between different input ports through the phase shifter 108 can alter the beam direction. For example, the dual beam of the array antenna shown in FIG. 35 can achieve a phase scan of ±45°, among them, +45° refers to a deviation of 45° from the normal direction in one direction, while −45 ° refers to a deviation of 45° from the normal direction in the opposite direction.

FIG. 37 exemplarily illustrates the structural diagram of another array antenna. As shown in FIG. 37, the phase shifter 108 can be connected between the output port of the circularly polarized antenna 100 and the input terminal 32a of the antenna unit, that is, between the output port of the branch-line coupler 104 and the input terminal 32a of the power divider module 32. In this way, the phase shifter 108 can be used to compensate for the phase of the signal at the output port of the branch-line coupler 104, achieving more forms of beam pointing.

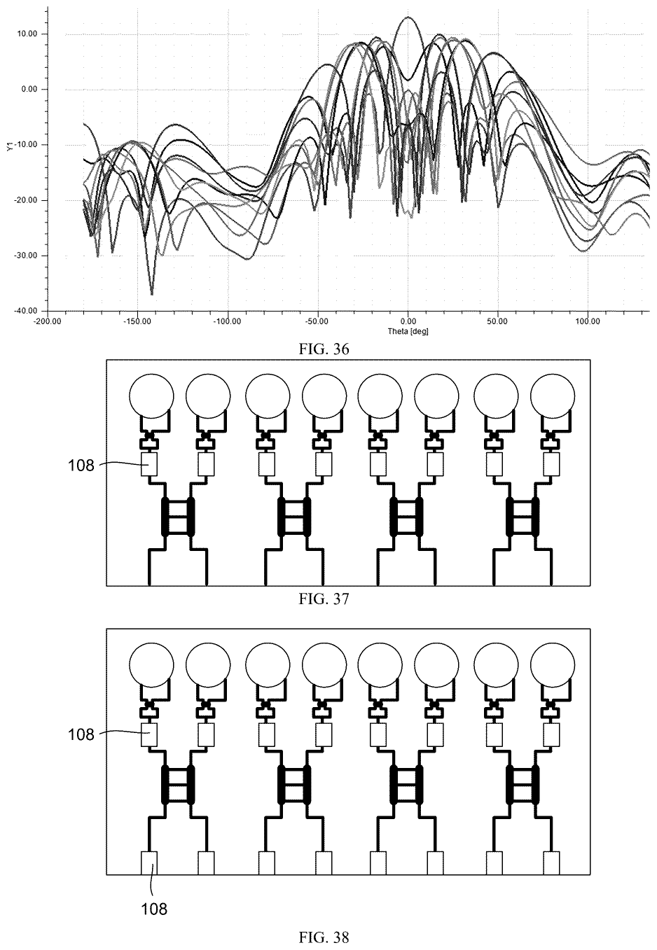

FIG. 38 exemplarily illustrates the structural diagram of another array antenna. As shown in FIG. 38, the phase shifter 108 is installed between the output port of the circularly polarized antenna 100 and the input terminal 32a of the antenna unit. At the same time, the phase shifter 108 is also installed between the output port of the circularly polarized antenna 100 and the input terminal 32a of the antenna unit.

For example, the plurality of antenna units are arranged at intervals along the first direction X, and can include odd antenna elements and even antenna elements in order from left to right. The phase shifter 108 controls the left beam scanning by adjusting the phase fed into the odd antenna units, and controls the right beam scanning by adjusting the phase fed into the even antenna units, achieving the function of independent scanning of the left and right beams.

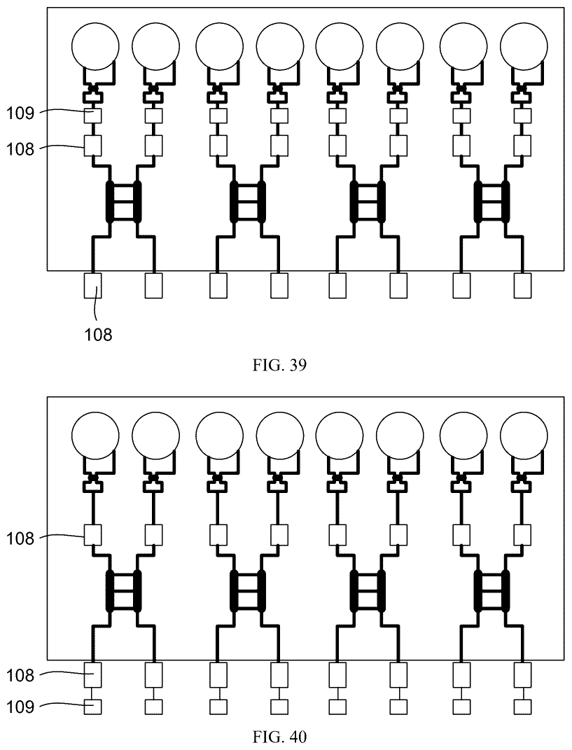

FIG. 39 exemplarily illustrates the structural diagram of another array antenna. As shown in FIG. 39, the array antenna also includes a power regulator 109, which is configured to amplify or attenuate electrical signals. The power regulator 109 can be connected to the input port of the circularly polarized antenna 100, as shown in FIG. 40. The power regulator 109 can also be connected between the output port of the circularly polarized antenna 100 and the input terminal 32a of the antenna unit, or can be connected between the input port of the circularly polarized antenna 100 and the input terminal 32a of the antenna unit and simultaneously connected between the output port of the circularly polarized antenna 100 and the input terminal 32a of the antenna unit.

The power regulator 109 can be an amplifier or an attenuator. The amplitude of the current signal fed into the antenna unit can be adjusted through the power regulator 109. Among them, the current signals fed into each antenna unit can be Taylor distribution or Chebyshev distribution to reduce sidelobes. The current signals fed into each antenna unit can also be current signals that gradually increase or decrease.

In addition, the power regulator 109 can also compensate for the energy loss caused by the current signal passing through the phase shifter 108 and the branch-line coupler 104.

The above is only a specific implementation of the present disclosure, but the scope of protection of the present disclosure is not limited to this. Any person skilled in the art can easily think of changes or replacements within the technical scope disclosed in the present disclosure, which should be included in the scope of protection of the present disclosure. Therefore, the scope of protection of the present disclosure should be based on the scope of protection of the claimed rights.

1. A circularly polarized antenna, comprising a radiating patch, a ground layer, a dielectric layer and a power divider module; wherein the radiating patch and the ground layer are arranged opposite to each other, and the dielectric layer is located between the radiating patch and the ground layer;
the power divider module comprises an input terminal and two output terminals, a phase difference between output signals of the two output terminals is 90°; the radiating patch comprises a first feed point and a second feed point, the first feed point is electrically connected to one of the two output terminals, and the second feed point is electrically connected to the other one of the two output terminals; and
a virtual connection line of the first feed point and a center of the radiating patch is regarded as a first line, a virtual connection line of the second feed point and the center of the radiating patch is regarded as a second line, and an angle between the first line and the second line is less than 90°.

2. The circularly polarized antenna according to claim 1, wherein the power divider module comprises a power divider, a first signal line and a second signal line; the power divider comprises a first output terminal and a second output terminal, the first signal line is electrically connected to the first output terminal and the first feed point, the second signal line is electrically connected to the second output terminal and the second feed point, and lengths of the first signal line and the second signal line are different.

3. The circularly polarized antenna according to claim 2, wherein the circularly polarized antenna further comprises a first conductive layer connected to one side of the dielectric layer away from the ground layer; the radiating patch, the power divider, the first signal line and the second signal line are located on the first conductive layer.

4. The circularly polarized antenna according to claim 3, wherein the first conductive layer has two virtual straight lines that are parallel and arranged at an interval, the radiating patch is connected to the two virtual straight lines, and the radiating patch, the first signal line, the second signal line and the power divider are located between the two virtual straight lines.

5. The circularly polarized antenna according to claim 2, wherein the first signal line comprises a first feed segment, the first feed segment is electrically connected to the first feed point, the second signal line comprises a second feed segment, the second feed segment is electrically connected to the second feed point, and the first feed segment and the second feed segment are parallel and arranged at an interval.

6. The circularly polarized antenna according to claim 2, wherein phases of output signals of the first output terminal and the second output terminal are the same.

7. The circularly polarized antenna according to claim 2, wherein a length difference between the first signal line and the second signal line is 2.8~3.8 mm, and/or, a distance between the first feed point and the second feed point is 4.9~5.9 mm.

8. The circularly polarized antenna according to claim 1, wherein a shape of the radiating patch is circular, polygonal, or irregular.

9. The circularly polarized antenna according to claim 1, wherein one radiating patch and one power divider module that are electrically connected forms an antenna unit, and the circularly polarized antenna comprises at least two antenna units; and
the circularly polarized antenna further comprises a branch-line coupler, the branch-line coupler comprises a plurality of input ports and at least two output ports, a phase difference between output signals of two adjacent of the at least two output ports is 90°, and each of the at least two output ports is connected to the antenna unit.

10. The circularly polarized antenna according to claim 9, wherein two adjacent radiating patches are arranged at an interval, and a distance between centers of the two adjacent radiating patches is half of a spatial wavelength.

11. The circularly polarized antenna according to claim 10, wherein a plurality of conductive pillars are provided between the two adjacent radiating patches, and an axial direction of each of the plurality of conductive pillars is perpendicular to the ground layer;
and/or, a neutralization line is provided between the two adjacent radiating patches, one end of the neutralization line is electrically connected to one of the two adjacent radiating patches, and the other end of the neutralization line is electrically connected to the other one of the two adjacent radiating patches;
and/or, the ground layer is provided with a defective ground structure.

12. The circularly polarized antenna according to claim 11, wherein the dielectric layer is provided with a plurality of openings, and the plurality of conductive pillars are arranged in the plurality of openings.

13. The circularly polarized antenna according to claim 10, wherein the circularly polarized antenna comprises at least three antenna units, and the branch-line coupler comprises at least three output ports.

14. The circularly polarized antenna according to claim 13, wherein filters are connected between the at least three output ports and the input terminal.

15. An array antenna, comprising a plurality of circularly polarized antennas according to claim 1, wherein the plurality of circularly polarized antennas are arranged in an array.

16. The array antenna according to claim 15, wherein the plurality of circularly polarized antennas comprises a plurality of circularly polarized antenna rows, a plurality of circularly polarized antennas in each of the plurality of circularly polarized antenna rows are arranged at an interval along a first direction, two adjacent circularly polarized antennas in each of the plurality of circularly polarized antenna rows are staggered by a predetermined distance along a second direction, and the first direction intersects with the second direction.

17. The array antenna according to claim 15, wherein the array antenna further comprises a phase shifter, the phase shifter is connected to an input port of the circularly polarized antenna, and/or, the phase shifter is connected between an output port of the circularly polarized antenna and an input terminal of an antenna unit.

18. The array antenna according to claim 17, wherein the phase shifter is a liquid crystal phase shifter, and the dielectric layer serves as a substrate of the liquid crystal phase shifter.

19. The array antenna according to claim 15, wherein the array antenna further comprises a power regulator, the power regulator is configured for amplifying or attenuating electrical signals; the power regulator is connected to an input port of the circularly polarized antenna, and/or the power regulator is connected between an output port of the circularly polarized antenna and an input terminal of an antenna unit.

20. A communication terminal, comprising the array antenna according to claim 15.
